(19) United States
(12) Patent Application Publication
(10) Pub. No.: US 2011/0011041 A1
(43) Pub. Date: Jan. 20, 2011

(54) Vacuum Cyclone Dust Collector

(76) Inventors: Hyung Seong Bae, Gyeongju-city (KR); Jeong Hee Park, Gyeongju-city (KR)

Correspondence Address: Robert D. Atkins, 605 W. Knox Road, Suite 104, Tempe, AZ, 85284, US

(21) Appl. No.: 12/716,165

(22) Filed: Mar. 2, 2010

(30) Foreign Application Priority Data
Jul. 14, 2009 (KR) 1020090064199

(51) Int. Cl. B01D 50/00

(52) U.S. Cl. 55/289; 55/337

(57) ABSTRACT

A vacuum cyclone dust collector according to the present invention comprises an upper housing through which an absorption hole and a discharging hole are formed and inside which air is inputted and discharged, a lower housing which induces air, which is inputted inside the upper housing through the absorption hole, to be circulated and is connected detachably to the lower part of the upper housing, and air refining part which is arranged rotatably to the upper part of the upper housing with keeping a vacuum state and allows air being inputted through the absorption hole to be circulated inside the upper housing and the lower housing and fine dust and impurities contained in air being inputted through the absorption hole to be dropped downward and refined air without fine dust and impurities to be discharged through the discharging hole.

### CLAIM TO FOREIGN PRIORITY

The present patent application claims the benefit of priority of Korean Application No. 10-2009-0064199, filed Jul. 14, 2009 and claims priority to the foregoing parent application pursuant to 35 U.S.C. §119(b).

### FIELD OF THE INVENTION

The present invention relates to a vacuum cyclone dust collector, and more particularly, to a vacuum cyclone dust collector into which air is absorbed and fine dust and impurities contained therein are removed and then refined air is discharged wherein fine dust absorbed and attached to a filtering part is removed efficiently through the filtering part of an air refining part and a brushing part installed closely to the filtering part and then dropped to lower part of a housing, avoiding an efficiency of the filtering part being decreased as time passes and keeping constantly inherent capacity of the dust collector.

### BACKGROUND OF THE INVENTION

Generally, a dust collector is used for removing fine dust and impurities contained in air being inputted and circulating the air, that is, refined air wherein the dust collector comprises an air inflow port through which air is inputted, an air discharging port, a dust collection network and dust collection filter for filtering fine dust and impurities contained in air.

For this purpose the prior dust collector is provided with a compressor for compressing air being inputted to a predetermined pressure and this fine dust and impurities contained in air are removed efficiently. Furthermore, under the prior art, the air is induced to go through a dust collecting filter after being inputted and the fine dust and impurities contained in air being inputted to inside the dust collector are removed.

However, according to the prior dust collector using the compressor for compressing air being inputted, a user does not recognize easily in appearance a capacity decrease of the dust collector and further when inner part of the dust collector is cleaned, the dust collector has to be stopped and thus it cannot be used efficiently.

Furthermore, when fine dust and impurities contained in air being absorbed into the dust collector through a dust collection filter, the fine dust and impurities are absorbed and adhered to the dust collection filter as time passes, causing overall efficiency of the dust collector to be decreased and thus the dust collector has to be replaced to return its capacitor or cleaning work has to be performed after stopping the dust collection device in order to keep the efficiency thereof be constant.

Under a configuration of this prior dust collector inner part of the dust collector is not easy to be cleaned and thus it can not be used efficiently with keeping efficiency of the dust collector to be constant and further the efficiency of the dust collector is not kept to be constant as time passes.

### SUMMARY OF THE INVENTION

The present invention has been proposed to solve the aforementioned drawbacks and an object of the present invention relates to provide a vacuum cyclone dust collector in which air is absorbed through an absorption hole of an upper housing and cleaned smoothly by a rotation of a filtering part of an air refining part in order for air to be circulated inside the upper housing and lower housing and then fine dust and impurities have been contained in air are dropped automatically on the lower part of the lower housing so that the fine dust and impurities contained in air are removed efficiently.

Additionally, another objective of the present invention relates to providing a vacuum cyclone dust collector in which fine dust being attached to the filtering part is removed efficiently during absorption and cleaning air through filtering part of an air cleaning part and a brush part arranged closely to the filtering part, and then dropped to lower part of the lower housing so that efficiency of the filtering part avoids being decreased as time passes and further intrinsic capacity of the dust collector is kept constantly.

In order to achieve the objective of the present invention, a vacuum cyclone dust collector comprises: an upper housing through which an absorption hole and a discharging hole are formed, and inside which air is inputted and outside which air is discharged; a lower housing which induces air, which is inputted inside the upper housing through the absorption hole, to be circulated and is connected detachably to the lower part of the upper housing; and air refining part which is arranged rotatably to the upper part of the upper housing with keeping a vacuum state, and allows air being inputted through the absorption hole to be circulated inside the upper housing and the lower housing and fine dust and impurities contained in air being inputted through the absorption hole to be dropped downward and refined air without fine dust and impurities to be discharged through the discharging hole.

At this time, the air refining part comprises: an operation part which is arranged on upper part of the upper housing and rotated around the discharging hole; a belt pulley plate which surrounds and supports external part of the operation part; a filtering part which is assembled tightly to the lower part of the operation part to make a vacuum state and refines air being inputted inside the upper housing and the lower housing through the absorption hole; a filter vacuum case which is assembled tightly to the belt pulley plate to surround external part of the filtering part so that the operation part and the filtering part are assembled tightly; and a brush part which is assembled tightly to external part of the filtering part toward inner part of the filter vacuum case so that external dust of the filtering part is brushed down.

Additionally, the operation part comprises: a rotation plate on inner part of which a through-hole is formed and which is connected rotatably to inner part of the upper housing and on the lower part of which a connection bar extending as same straight as the discharging hole is provided; a pull belt pulley which is connected to the upper part of the rotation plate and rotated corresponding to the rotation plate; and a motor which is provided with a rotation pulley being connected to the pull belt pulley through a main pulley for transferring rotation force to the pull belt pulley, and is connected to the upper part of the upper housing wherein when the pull belt pulley and the rotation pulley are connected, the rotation pulley is rotated depending on rotation of the motor and rotation force of the rotation pulley is transferred to the pull belt pulley through the main pulley to rotate the rotation plate.

Furthermore, the filtering part comprises: a filter case on inner middle of which a through-hole into which the connection bar is connected throughly; a cartridge filter which surrounds external part in a lengthwise direction of the filter case and is connected thereto; and a back filter which surrounds external part of the cartridge filter and is connected thereto, and the filter case comprises: a sponge pad which is provided a location closely to the operation part; a fixing bolt which is fastened to the connection bar passing through the filter case; and a filter fixing plate in which a fastening hole through which the connection bar passes is formed and which is installed interposed between the fixing bolt and the filter case.

Meanwhile, a seating groove through which the filter fixing plate is inserted is further provided on the lower part of the filter case.

Furthermore, the filter vacuum case comprises: a cylindrical vacuum case which is assembled tightly through installing the belt pulley plate and the sponge pad; a fastening bar which is formed as a bar shape connecting inner opposing surfaces of the vacuum case and on inner middle part of which a connection hole through which the connection bar passes; and a connection bolt which is fastened to the connection bar connected to the connection hole and restricts the connection bar and the vacuum case.

Here, the filtering part comprises a filter case on inner middle part of which a through-hole through which the connection bar passes is formed, and a cartridge filter which surrounds external part in a lengthwise direction of the filter case and is connected thereto, and a back filter which is connected to surround external part of the cartridge filter, and the brush part comprises a fixing plate which is arranged inner side of the vacuum case and a plurality of brush which are arranged closely to the back filter toward one side of the fixing plate.

Meanwhile, the brush is extended downward within an angle of 30-50° to one side of the fixing plate, and further forms inclination of 30-50° along outer peripheral circumference of the back filter.

In addition, a bearing (B) is further provided on a part of the pull belt pulley which is assembled tightly to the upper housing.

According to the vacuum cyclone dust collector of the present invention, the following effects can be obtained.

Firstly, air is absorbed through an absorption hole of an upper housing and cleaned smoothly by a rotation of a filtering part of an air refining part in order for air to be circulated inside the upper housing and lower housing and then fine dust and impurities have been contained in air are dropped automatically on the lower part of the lower housing so that the fine dust and impurities contained in air are removed efficiently.

Secondly, fine dust being attached to the filtering part is removed efficiently during absorption and cleaning air through filtering part of an air cleaning part and a brush part arranged closely to the filtering part, and then dropped to lower part of the lower housing so that efficiency of the filtering part avoids being decreased as time passes and further intrinsic capacity of the dust collector is kept constantly.

Thirdly, fine dust and impurities contained in air are removed efficiently through a cartridge filter and back filter surrounding outer part of a filter case and further even when the back filter becomes less capable as time passes, it can be disassembled and replaced easily.

Fourth, vacuum state inside the filtering part is kept efficiently through connection of an operation part and the filtering part and connection of a belt pulley plate and a filter vacuum case and further even when the connections are made, sponge pads are interposed between them, the vacuum state inside the filter part are kept efficiently, causing fine dust and impurities to be removed efficiently.

Fifth, since the upper housing, the lower housing, and the air refining part are assembled simply, they are disassembled and replaced easily when they fail, causing their use to be convenient and saving cost.

### BRIEF DESCRIPTION OF THE DRAWINGS

FIG. 1 is a side sectional view of a vacuum cyclone dust collector according to the present invention;

FIG. 2 is an enlarged view of a filtering part of a vacuum cyclone dust collector as main elements according to the present invention;

FIG. 3 is a side sectional view showing an assembled sate of a vacuum cyclone dust collector according to the present invention;

FIGS. 4(a) and 4(b) are enlarged views showing assembled states of brushes as main element according to the present invention;

FIG. 5 is a plan view showing air input procedures for a vacuum cyclone dust collector according to the present invention; and

FIG. 6 is a side sectional view showing air circulation procedures for a vacuum cyclone dust collector according to the present invention.

### DETAILED DESCRIPTION OF THE DRAWINGS

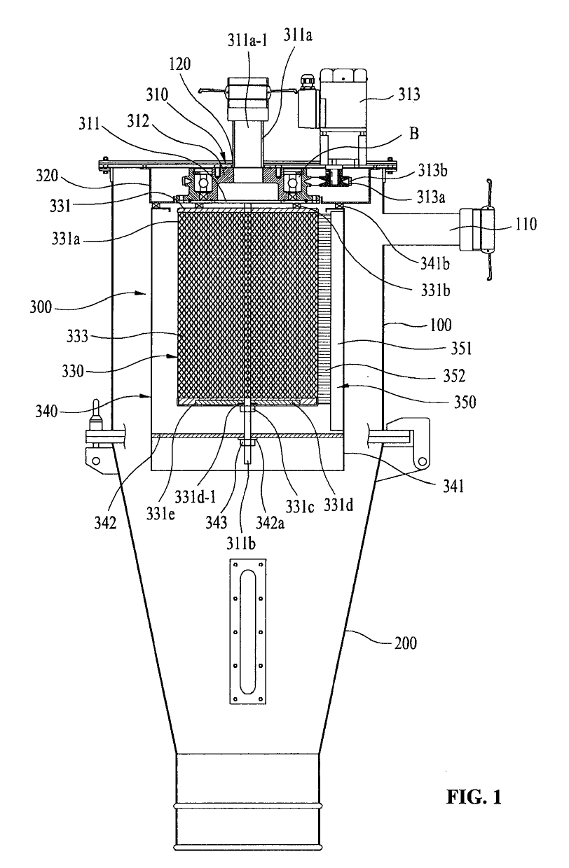

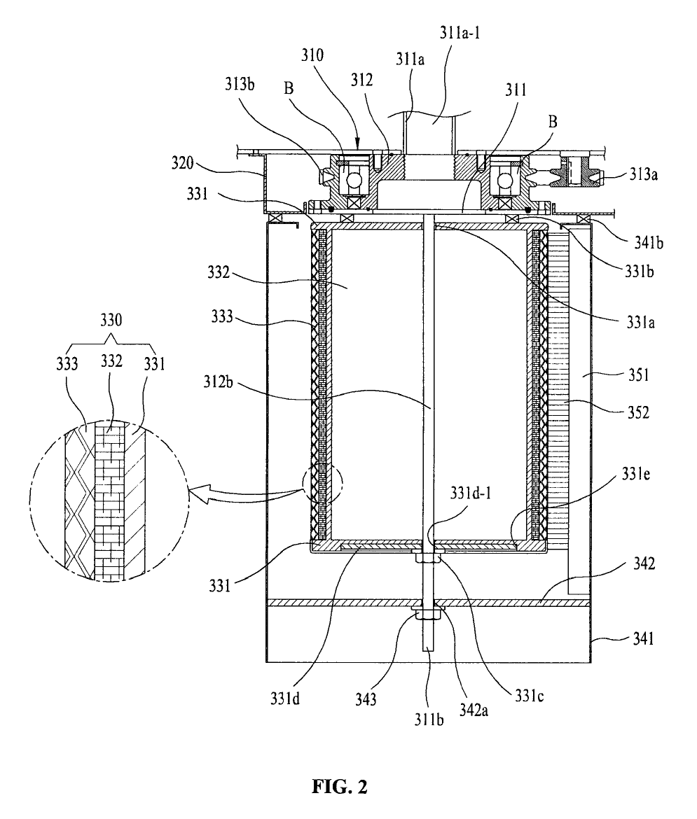

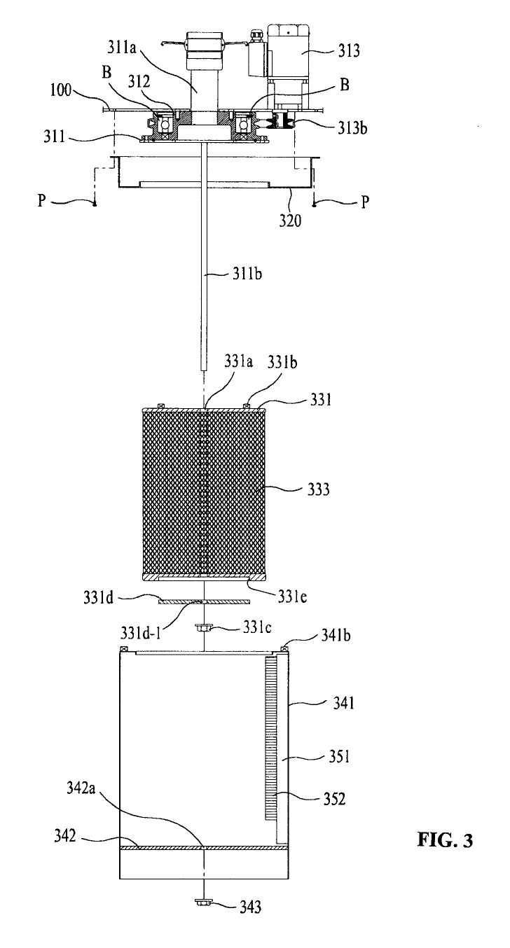

Hereinafter, preferred embodiments of a vacuum cyclone dust collector according to the present invention will be described referring to attached drawings. Here, FIG. 1 is a side sectional view of a vacuum cyclone dust collector according to the present invention, FIG. 2 is an enlarged view of a filtering part of a vacuum cyclone dust collector as main elements according to the present invention, and FIG. 3 is a side sectional view showing an assembled sate of a vacuum cyclone dust collector according to the present invention.

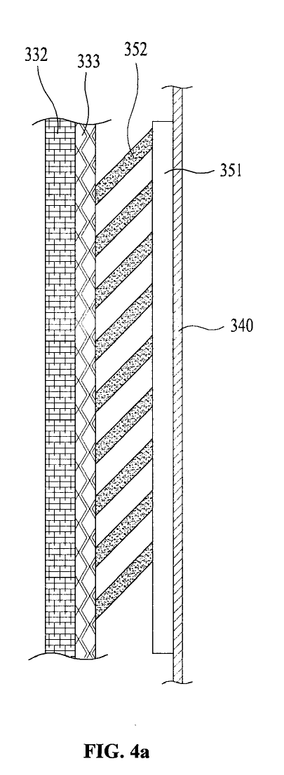

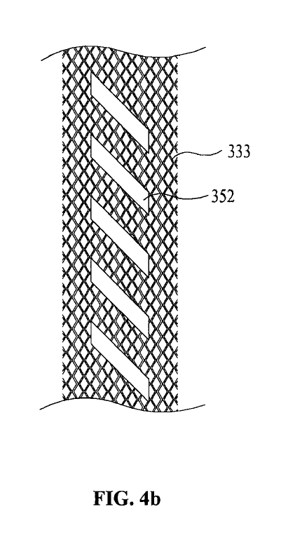

In addition, FIGS. 4(a) and 4(b) are enlarged views showing assembled states of brushes as main element according to the present invention.

As shown in the drawings, the vacuum cyclone dust collector according to the present invention comprises an upper housing 100, a lower housing 200 and air refining part 300.

At this time, the upper housing includes an absorption hole 110 and a discharging hole 120, through which air is absorbed inside the housing and discharged outside the housing, respectively.

Furthermore, the lower housing 200 is configured such that air inputted inside the upper housing 100 through the absorption hole 110 is circulated smoothly, and is assembled detachably to lower end of the upper housing 100.

Additionally, the air refining part 300 is arranged to an upper part of the upper housing 100 and rotated in a state of vacuum. Here, the air refining part 300 allows air being inputted through the absorption hole 120 to be circulated inside the upper housing 100 and the lower housing 200, and fine dust and impurities contained in the air being inputted through the absorption hole 110 to be dropped to lower part of the lower housing 200, and air without fine dust and impurities, that is, refined air, to be discharged to the discharging hole 120.

Here, the upper housing 100 and the lower housing 200 are configured corresponding to a size of the air refining part 300, and preferably, as shown in FIG. 1, the lower housing 200 which is connected to the lower part of the upper housing 100 is shaped as upper wide-lower narrow so that air flow being circulated inside the upper housing 100 and the lower housing 200 is made smoothly.

Furthermore, more preferably, the upper housing 100 and the lower housing 200 are hinged (not shown) so that the upper housing 100 is replicated toward one side of the lower housing 200 and further upper part of the lower housing 200 can be opened.

Meanwhile, the air refining part 300 comprises an operation part 310 which is arranged rotatably around the discharging hole 120 on the upper part of the upper housing 100, a belt pulley plate 320 which surrounds and supports the outer part of the operation part 310, a filtering part 330 which is assembled tightly to the lower part of the operation part 310 to make a vacuum state therein and refines air being inputted inner side of the upper housing 100 and the lower housing 200 through the absorption hole 120, a filter vacuum case 340 which is assembled tightly to the belt pulley plate 320 for surrounding the outer part of the filtering part 330 and allows the operation part 310 and the filtering part 330 to be closely, and a brush part 350 for brushing down dust on the outer part of the filtering part 320, which is arranged on inner part of the filter vacuum case 340 and tightly to the outer part of the filtering part 320.

At this time, the operation part 310 comprises a rotation plate 311 which is connected rotatably to inner and outer part of the upper housing 300, a pull belt pulley 312 which is seated on the upper part of the rotation plate 311 to be rotated correspondingly to the rotation plate 311, and a motor 313 which transfers rotation force to the pull belt pulley 312.

Furthermore, a connection pipe 311a is extended from the rotation plate 311 toward the upper part of the upper housing 100 to pass through the discharging hole 120 formed on the upper housing 100 and further a connection bar 311b is extended from the lower part of the rotation plate to be the same straight as the discharging hole 120.

At this time, the connection pipe 311a may be formed as arbitrary configuration on a condition that the rotation plate 311 is arranged on the upper housing 100 and rotated smoothly thereon. Additionally, the connection bar 311b may be formed as arbitrary configuration on a condition that the filtering part 330 and the filter vacuum case 340 are connected efficiently.

As shown in the drawings, the connection pipe 311a passes through the upper part of the upper housing 100 and allows the rotation plate 311 to be rotated and further the connection bar 311b may be formed as a straight bar corresponding to the discharging hole 120.

In addition, the pull belt pulley 312 is connected to the upper part of the rotation plate 311 to be rotated correspondingly to the rotation plate 311 and transfers rotation force of the motor 313 to the rotation plate 311. For this purpose a rotation pulley 313a which is rotated correspondingly to rotation of the motor 313 is provided on the motor 313, as shown in FIGS. 1 and 2, and the pull belt pulley 312 and the rotation pulley 313a are connected through a main pulley 313b.

As a result, when the motor 313 is rotated, the rotation pulley 313a is rotated and at the same time the main pulley 313b which connects the rotation pulley 313a to the pull belt pulley 312 is moved to rotate the pull belt pulley 312.

That is, the pull belt pulley 312 is rotated according to rotation of the motor 313 so that the rotation plate 311 is rotated corresponding to rotation of the motor 313.

At this time, the rotation plate 311 is rotated around the connection pipe 311a which passes through the discharging hole 120 of the upper housing 100.

In addition, a through-hole 311a-1 is formed in a lengthwise direction of the connection pipe 311a so that air being inputted inside the upper housing 100 is discharged.

Here, bearing B is installed on the pull belt pulley 312 so that when the motor 313 is operated, the rotation plate 311 is rotated smoothly around the connection pipe 311a.

Meanwhile, the motor 313 is operated through external power source and even it is not shown in detail in the present invention, separate power switch and control switch (not shown) to control the motor 313 may be provided.

The belt pulley plate 320 surrounding external part of the operation part 310 avoids fine dust and impurities D being fitted into the operation part 310 and being interferred of rotation and further when the dust collector is fabricated, the pulley plate is fastened firmly to the lower part of the upper housing 100 through a fastening bolt P in order that damage to a body of a user, which may be caused by rotation of the rotation plate 311 and the pull belt pulley 312 can be avoided.

Here, the filtering part 330, as shown in FIGS. 2 and 3, is assembled tightly to the belt pulley plate 320 and thus air being inputted inside the upper housing 100 is refined and further the filtering part 330 comprises a filter case 331 on inner middle part of which a through-hole 331a through which the connection bar 311b passes is formed, a cartridge filter 332 surrounding external part of the filter case 331, and a back filter 333 surrounding external part of the cartridge filter 332.

At this time, rotation force from the motor 313 is transferred to the filter case 331 and the rotation plate 311 is rotated, and when the connection bar 311b provided on the rotation plate 311 is rotated, the filter case 331 is rotated below the operation part 310.

That is, the filter case 331 is connected to the connection bar 311b so that the filter case can be rotated below the operation part 310 depending on rotation of the operation part 310.

Furthermore, a cartridge filter 332 is connected lengthwise to external part of the filter case 331 to surround external part of the filter case 311 and further a back filter 333 is connected to external part of the filter case 331 to surround external part of the cartridge filter.

Through this configuration fine dust and impurities contained in air being inputted inside the upper housing 100 are screened through the cartridge filter 332 and the back filter 333.

For example, as shown in FIG. 2, the cartridge filter 332 and the back filter 333 are connected in a sequence to external part of the filter case 331.

According to this configuration fine dust and impurities contained in air being inputted inside the upper housing 100 are screened dually and further when the back filter 333 becomes obsolete, it can be replaced easily.

In addition, a fixing bolt 331c is fastened to the connection bar 311b which is connected throughly to the filter case 331, as shown in FIGS. 1, 2, 4a and 4b. When the fixing bolt 331c is fastened to the connection bar 331b, a fastening state of the fixing bolt is controlled such that the fixing bolt 331c moves the filter case 311 toward the operation part 310 and thus a tight connection state of the operation part 310 and the filter case 331 is kept.

Furthermore, a filter fixing plate 331d in which a fastening hole 331d-1 through which the connection bar 311b passes is formed may be further provided between the fixing bolt 331c and the filter case 331 such that the fixing bolt 331c fastened to the connection bar 311b assembles further smoothly to the filter case 331 toward the operation part 310.

Here, a seating groove 331e into which the filter fixing plate 331b is inserted is further formed on lower part of the filter case 331 so that the filter fixing plate 331b connected to the lower part of the filter case 331 is located firmly.

Through this configuration even when a separate fastening device (not shown) is not used for the filter case 331 to be connected to the operation part 310, the filter case 331 can be assembled tightly to the lower part of the operation part 310 through an adjustment of the fixing bolt 331c.

In more detail description of a connection of the operation part 310 and the filtering part 330, the motor 313 of the operation part 310 is operated to rotate the rotation pulley 313a of the motor 313 and as a result the pull belt pulley 312 connected to the rotation pulley 313a through the main pulley 313b is rotated, causing the rotation plate 311 to be rotated.

At the same time, the connection pipe 311a connected to the lower part of the rotation plate 311 is rotated and the filtering part 330 connected to the rotation plate 311 through the fixing bolt 313c is rotated, making inside the filtering part 330 to be vacuum.

As a result, air is inputted inside the filtering part 330 and fine dust and impurities contained in air are screened through the cartridge filter 332 and the back filter 333.

Furthermore, a sponge pad 331b is provided on the filter case 331 at a location where the operation part 310 is assembled tightly so that inner part of the filter case 331 is kept efficiently as a vacuum state and avoids the filter case 331 being damaged even when the operation part 310 and the filter case 331 are assembled excessively.

Meanwhile, the filter vacuum case 340, which surrounds external part of the filtering part 330 and is assembled tightly to the lower part of the belt pulley plate 320, comprises the vacuum case 341 which is assembled tightly through installing the belt pulley plate 320 and the sponge pad 341a, the fastening bar 342 which is provided on the lower part of the vacuum case 341 such that it can be connected to the connection bar 311b connected throughly to the filter case 331, and a connection bolt 343 to be fastened to the connection bar 311b connected to the fastening bar 342.

Furthermore, the vacuum case 341 may be formed preferably to be assembled tightly to the belt pulley plate and the fastening bar 342 may be formed preferably as a bar shape connecting inner side opposing surfaces of the vacuum case 341.

At this time, a connection hole 342a through which the connection bar 311b passes is formed on the fastening bar 342, and the connection bolt 343 is fastened to the connection bar 311b passing through the connection hole 342a.

That is, through this configuration when the vacuum case 341 is configured to surround the filtering part 330, the connection bolt 343 fastened to the connection bar 311b is adjusted such that the vacuum case 341 is assembled tightly toward the belt pulley plate 320.

In addition, inner vacuum state of the filtering part 330 located inside the filter case 331 and the vacuum case 341 can be formed efficiently through the sponge pad 341a provided therebetween.

Here, the brush part 350 is a main element for achieving an objective of the present invention, and comprises a fixing plate 351 arranged inside the vacuum case 341, and a plurality of brushes 352 are installed on one side of the fixing plate 351 and arranged closely to the back filter 333.

Meanwhile, the fixing plate 351 is provided in a lengthwise direction of the vacuum case 341 such that the brush 352 is fixed firmly to inner side of the vacuum case 341, and fixing plate 351 and the brush 352 may be formed integrally, and further a configuration arranged inside the vacuum case 341 may be varied depending on user's choice.

However, when air being inputted inside the upper housing 100 is absorbed and cleaned through the filtering part 330 being rotated depending on operation of the operation part 310, the brushes may be arranged on one side of the fixing plate 351 downward at an angle of 30-50° and form an inclination angle of 30-50° along outer peripheral circumference, as shown in FIGS. 4a and 4b, so that fine dust and impurities attached to the filtering part 330 are brushes down efficiently.

For example, the brush 352 assembled tightly to the back filter 333 of the filtering part 330 brushes down fine dust and impurities absorbed and attached to external part of the back filter 333 depending on rotation of the filtering part 330 and further forms inclination of within 30-50° along outer peripheral circumference of the back filter 333 and thus fine dust and impurities brushed down from external part of the back filter 333 are not hung over the brush 352 and dropped to the lower part of the lower housing 200.

As aforementioned, the brushes 352 are arranged at a predetermined distance in a lengthwise direction of the fixing plate 351 in order that fine dust and impurities brushed down from the back filter 333 are not to be hung over the brush 352.

However, a configuration of the brush 352 and the back filter 333 being assembled closely may be modified variably depending on user's choice.

Meanwhile, even though connections of the operation part 310, the belt pulley plate 320, the filtering part 330, and the filter vacuum case 340 are not described in detail, they may be arbitrary type on a condition that the filtering part 330 is rotated efficiently depending on an operation of the operation part 310.

Operations of the vacuum cyclone dust collector according to the present invention are follows.

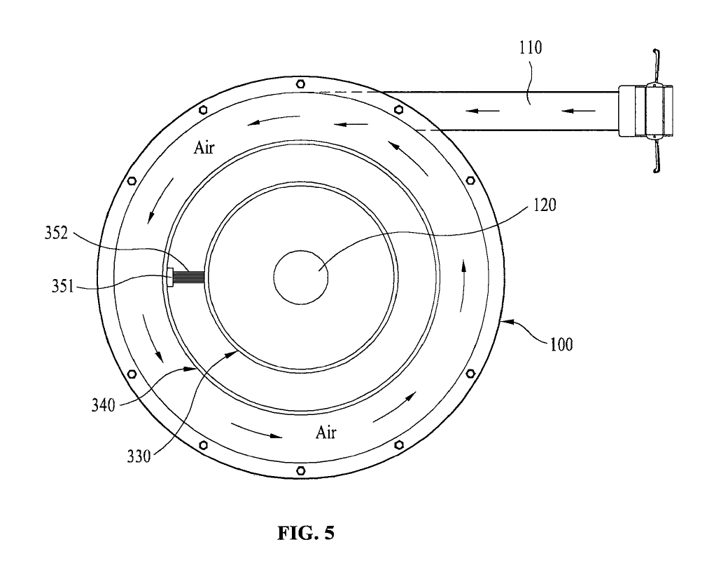

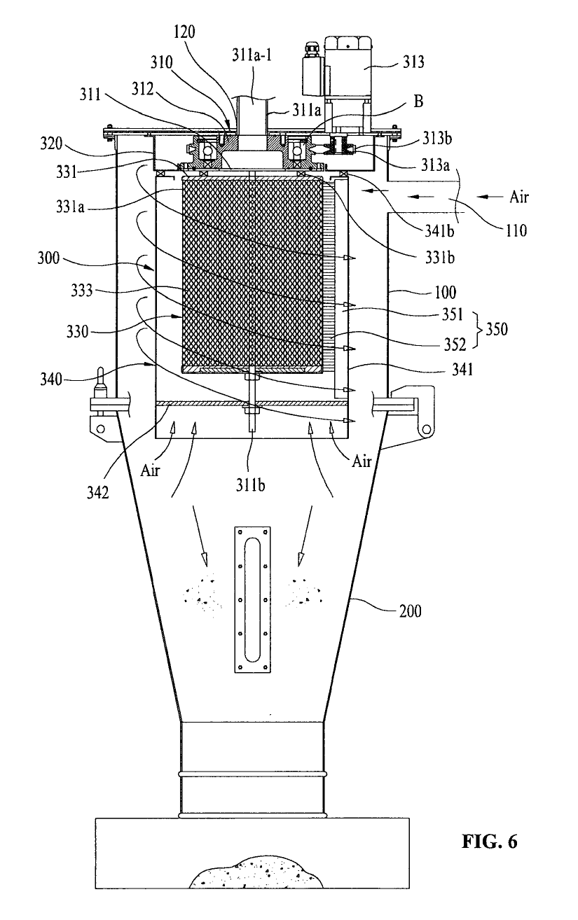

FIG. 5 is a plan view showing air input procedures for a vacuum cyclone dust collector according to the present invention, and FIG. 6 is a side sectional view showing air circulation procedures for a vacuum cyclone dust collector according to the present invention.

First, as shown in the drawings, external contaminated air is absorbed through the absorption hole 110 of the upper housing 100 and at the same time the operation part 310 is operated to circulate the air inside the upper housing 100 and the lower housing 200 along external part of the vacuum case 341.

In the aforementioned case, the filtering part 330 connected to the lower part of the operation part 310 is rotated depending on an operation of the operation part 310 and as a result inner side of the filtering part is kept as a vacuum state by rotation of the filtering part 330 so that air circulating inner side of the upper housing 100 and the lower housing 200 is absorbed to inner side of the filtering part 330.

At this time, fine dust and impurities contained in air being absorbed into the filtering part 330 is screened through the cartridge filter 332 of the filtering part 330 and the back filter surrounding external part of the cartridge filter 332.

Furthermore, as aforementioned, air circulating inner part of the upper housing 100 and the lower housing 200 and being screened fine dust and impurities is discharged outside through the through-hole 311a-1 of the connection pipe 311a connected to the discharging hole 120 of the upper housing 100.

In particular, fine dust and impurities screened depending on rotation of the filtering part 330 are absorbed and attached to external part of the back filter 333, and dropped down the lower housing 200 through the brush part 350 arranged facedly with the back filter 333 of the filtering part 330.

As a result, fine dust and impurities contained in air are removed efficiently through the filtering part 330 and at the same time even when the dust collector is used continuously, fine dust and impurities avoid being absorbed and attached to external surface of the filtering part 330, and thus without replacing the filtering part 330 the dust collector can be kept continuously at a high air refining efficiency.

Accordingly, the vacuum cyclone dust collector according to the present invention absorbs external contaminated air and cleans it and then fine dust and impurities contained in air are removed efficiently when it is re-discharged. At this time, inner elements of the dust collector have avoided failures and efficiency decrease of the dust collector can be avoided.

While the present invention is described referring to the preferred embodiment, the present invention is not limited thereto, and thus various variation and modification can be made without departing from a scope of the present invention.

What is claimed:

1. A vacuum cyclone dust collector comprising:
an upper housing (100) through which an absorption hole (110) and a discharging hole (120) are formed, and inside which air is inputted and outside which air is discharged;
a lower housing (200) which induces air, which is inputted inside the upper housing (100) through the absorption hole (110), to be circulated and is connected detachably to the lower part of the upper housing (100); and
air refining part (300) which is arranged rotatably to the upper part of the upper housing (100) with keeping a vacuum state, and allows air being inputted through the absorption hole (110) to be circulated inside the upper housing (100) and the lower housing (200) and fine dust and impurities contained in air being inputted through the absorption hole (110) to be dropped downward and refined air without fine dust and impurities to be discharged through the discharging hole (120).

2. A vacuum cyclone dust collector according to claim 1, wherein the air refining part (300) comprises:
an operation part (310) which is arranged on upper part of the upper housing (100) and rotated around the discharging hole (120);
a belt pulley plate (320) which surrounds and supports external part of the operation part (310);
a filtering part (330) which is assembled tightly to the lower part of the operation part (310) to make a vacuum state and refines air being inputted inside the upper housing (100) and the lower housing (200) through the absorption hole (120);
a filter vacuum case (340) which is assembled tightly to the belt pulley plate (320) to surround external part of the filtering part (330) so that the operation part (310) and the filtering part (330) are assembled tightly; and
a brush part (350) which is assembled tightly to external part of the filtering part (330) toward inner part of the filter vacuum case (340) so that external dust of the filtering part (330) is brushed down.

3. A vacuum cyclone dust collector according to claim 2, wherein the operation part (310) comprises:
a rotation plate (311) on inner part of which a through-hole (311a-1) is formed and which is connected rotatably to inner part of the upper housing (100) and on the lower part of which a connection bar (312b) extending as same straight as the discharging hole (120) is provided;
a pull belt pulley (312) which is connected to the upper part of the rotation plate (311) and rotated corresponding to the rotation plate (311); and
a motor (313) which is provided with a rotation pulley (313a) being connected to the pull belt pulley (312) through a main pulley (313b) for transferring rotation force to the pull belt pulley, and is connected to the upper part of the upper housing (100) wherein when the pull belt pulley (312) and the rotation pulley (313a) are connected, the rotation pulley (313a) is rotated depending on rotation of the motor (313) and rotation force of the rotation pulley (313a) is transferred to the pull belt pulley (312) through the main pulley (313b) to rotate the rotation plate (311).

4. A vacuum cyclone dust collector according to claim 3, wherein the filtering part (330) comprises:
a filter case (331) on inner middle of which a through-hole (331a) into which the connection bar (312b) is connected throughly;
a cartridge filter (332) which surrounds external part in a lengthwise direction of the filter case (331) and is connected thereto; and
a back filter (333) which surrounds external part of the cartridge filter (332) and is connected thereto, the filter case (331) comprising:
(a) a sponge pad (331b) which is provided a location closely to the operation part (310);
(b) a fixing bolt (331c) which is fastened to the connection bar (312b) passing through the filter case (331); and
(c) a filter fixing plate (331d) in which a fastening hole (331d-1) through which the connection bar (312b) passes is formed and which is installed interposed between the fixing bolt (331c) and the filter case (331).

5. A vacuum cyclone dust collector according to claim 4, wherein a seating groove (331e) through which the filter fixing plate (331d) is inserted is further provided on the lower part of the filter case (331).

6. A vacuum cyclone dust collector according to claim 3, wherein the filter vacuum case (340) comprises:
a cylindrical vacuum case (341) which is assembled tightly through installing the belt pulley plate (320) and the sponge pad (341a);
a fastening bar (342) which is formed as a bar shape connecting inner opposing surfaces of the vacuum case (341) and on inner middle part of which a connection hole (342a) through which the connection bar (312b) passes; and
a connection bolt (343) which is fastened to the connection bar (312b) connected to the connection hole (342a) and restricts the connection bar (312b) and the vacuum case (341).

7. A vacuum cyclone dust collector according to claim 6, wherein the filtering part (330) comprises a filter case (331) on inner middle part of which a through-hole (331a) through which the connection bar (312b) passes is formed, and a cartridge filter (332) which surrounds external part in a lengthwise direction of the filter case (331) and is connected thereto, and a back filter (333) which is connected to surround external part of the cartridge filter (332), and the brush part (350) comprises a fixing plate (341) which is arranged inner side of the vacuum case (341) and a plurality of brush (352) which are arranged closely to the back filter (333) toward one side of the fixing plate (351).

8. A vacuum cyclone dust collector according to claim 7, wherein the brush (352) is extended downward within an angle of 30-50° to one side of the fixing plate (351), and further forms inclination of 30-50° along outer peripheral circumference of the back filter (333).

9. A vacuum cyclone dust collector according to claim 3, wherein a bearing (B) is further provided on a part of the pull belt pulley (312) which is assembled tightly to the upper housing (100).
